(19) United States
(12) Patent Application Publication
(10) Pub. No.: US 2026/0247176 A1
(43) Pub. Date: Aug. 20, 2026

(54) DYNAMIC GNSS BLANKING

(71) Applicant: QUALCOMM Incorporated, San Diego, CA (US)

(72) Inventors: Haleh KARKHANEH, San Diego, CA (US); Soon-Seng LAU, San Diego, CA (US); Tarandeep VIRK, San Diego, CA (US); Shriram GURUMOORTHY, Denver, CO (US); Abhishek Ananthrao KULKARNI, Gulbarga (IN); Balasubramanian RAMACHANDRAN, Hyderabad (IN)

(21) Appl. No.: 19/479,419

(22) PCT Filed: Mar. 13, 2024
(86) PCT No.: PCT/US2024/019640

§ 371 Date: Oct. 28, 2025

(30) Foreign Application Priority Data
Jun. 30, 2023 (IN) 202341043943

(51) Int. Cl. H04W 24/02; H04W 52/36; H04W 84/06

(52) U.S. Cl. CPC H04W 24/02; H04W 52/367; H04W 84/06

(57) ABSTRACT

Certain aspects of the present disclosure provide techniques and apparatus for dynamic global navigation satellite system (GNSS) blanking. An exemplary method includes determining an uplink (UL) transmission to be sent via a first radio access technology (RAT) radio of the UE will occur during an operating session of a second RAT radio of the UE, performing a blanking operation on signals received using the second RAT radio during the operating session when one or more thresholds associated with the UL transmission are satisfied, and refraining from performing the blanking operation on the signals received using the second RAT radio during the operating session when the one or more thresholds associated with the UL transmission are not satisfied.

### CROSS-REFERENCE TO RELATED APPLICATIONS

This application claims benefit of and priority to Indian Application No. 202341043943, filed Jun. 30, 2023, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for dynamic global navigation satellite system (GNSS) blanking.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a desire for further improvements in wireless communications systems to overcome the aforementioned technical challenges and others.

### SUMMARY

One aspect provides a method for wireless communication by a user equipment (UE). The method includes determining an uplink (UL) transmission to be sent via a first radio access technology (RAT) radio of the UE will occur during an operating session of a second RAT radio of the UE, performing a blanking operation on signals received using the second RAT radio during the operating session when one or more thresholds associated with the UL transmission are satisfied, and refraining from performing the blanking operation on the signals received using the second RAT radio during the operating session when the one or more thresholds associated with the UL transmission are not satisfied.

Another aspect provides another method for wireless communication by the UE. The method includes determining an uplink (UL) transmission to be sent via a first radio access technology (RAT) radio of the UE will occur during an operating session of a second RAT radio of the UE and refraining from performing a blanking operation on signals received using the second RAT radio during the operating session when an antenna isolation, between a first antenna associated with the first RAT radio for the UL transmission and a second antenna associated with the second RAT radio for receiving the signals during the operating session, is greater than the threshold antenna isolation.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3A depicts aspects of an example base station and an example user equipment.

FIG. 3B is a block diagram conceptually illustrating a design of an example wireless communication device communicating with another device.

FIGS. 4A, 4B, 4C, and 4D depict various example aspects of data structures for a wireless communications network.

FIG. 5 depicts a method for wireless communications.

FIG. 6 depicts a method for determining a power threshold and using the power threshold for a blanking operation.

FIG. 7 includes a graph illustrating global navigation satellite system desense associated with out-of-band noise.

FIG. 8 depicts a method for determining an intermodulation distortion threshold and using the intermodulation distortion threshold for a blanking operation.

FIG. 9 includes a graph illustrating global navigation satellite system desense associated with intermodulation distortion.

FIGS. 10, 11, 12, 13, and 14 include tables illustrating when a dynamic global navigation satellite system blanking operation may be enabled or disabled.

FIG. 15 depicts aspects of an example communications device.

### DETAILED DESCRIPTION

Aspects of the present disclosure provide apparatuses, methods, processing systems, and computer-readable mediums for dynamic global navigation satellite system (GNSS) blanking.

In some cases, a user equipment (UE) may include multiple radios capable of communicating using different radio access technologies (RATs). For example, the UE may include a first RAT radio, such as a wireless wide area network (WWAN) radio. The WWAN radio may be used for WWAN communication, such as fifth generation new radio (5G NR) communication, fourth generation long term evolution (4G LTE) communication, and the like. The UE may also include a second RAT radio that may be used for receiving positioning data from satellites, such as a global navigation satellite system (GNSS) radio.

In some cases, when the WWAN radio and the GNSS radio are located close to each other in the UE, WWAN transmissions transmitted by the UE using the WWAN radio may interfere with GNSS transmissions received by the UE using the GNSS radio. This interference can cause problems like inaccurate positioning or a complete loss of a GNSS signal associated with the GNSS radio.

To reduce this interference, a technique known as GNSS blanking may be used. GNSS blanking temporarily stops the GNSS radio from using GNSS signals when interference from the WWAN radio is present in a time domain. During a time period in which GNSS blanking is being used, the GNSS radio may still track GNSS signals but may not use these signals for positioning, navigation, or timing. This may help to ensure that the interference caused by the WWAN transmissions does not affect the accuracy of the positioning measurements based on the GNSS signals.

While GNSS blanking is effective in reducing interference and improving performance of the GNSS radio of the UE, current GNSS blanking techniques are typically applied statically and may not take into account actual antenna isolation between the GNSS radio and WWAN radio, WWAN transmission bandwidth, or active WWAN transmission power, which may lead to inefficiencies when applying GNSS blanking. For example, current GNSS blanking techniques may lead to the UE performing GNSS blanking even in situations where WWAN transmissions transmitted using the WWAN radio may not cause a significant amount of interference to GNSS signals received using the GNSS radio. Such unnecessary GNSS blanking may result in an unnecessary reduction in the accuracy of positioning measurements performed by the UE and may increase positioning errors. This unnecessary GNSS blanking may also lead to a reduction in a WWAN data rate due to SCell drop at the UE as described below.

Accordingly, aspects of the present disclosure provide techniques for dynamic GNSS blanking. For example, these techniques may allow the UE to decide whether to perform GNSS blanking or refrain from performing GNSS blanking when a WWAN-based uplink (UL) transmission is to be sent during an operating session of a GNSS radio (e.g., during a time at which the GNSS radio is scheduled to receive a GNSS transmission). For example, in some cases, when the UE determines that one or more thresholds associated with the UL transmission are satisfied, the UE may be configured to perform a GNSS blanking operation on the signals received using a GNSS radio. However, when the UE determines that the one or more thresholds associated with the UL transmission are not satisfied, the UE may instead be configured to refrain from performing the GNSS blanking operation on the signals received using a GNSS radio. Accordingly, by refraining from performing the GNSS blanking operation in these scenarios, the UE may avoid the unnecessary reduction in the accuracy of positioning measurements and potential increase in position errors caused by unnecessary GNSS blanking, as well as the reduction in the WWAN data rate due to SCell drop at the UE.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

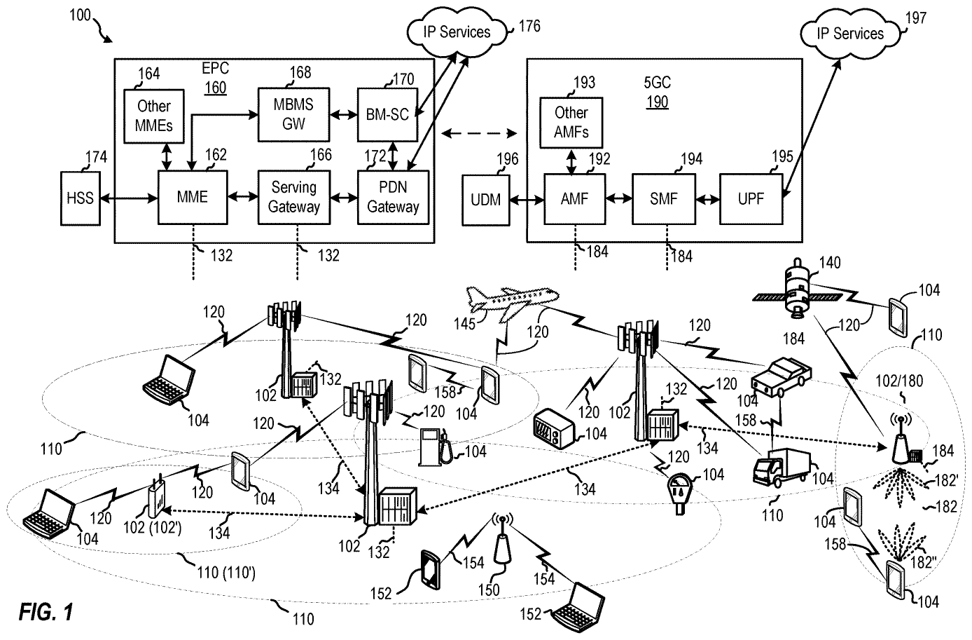

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

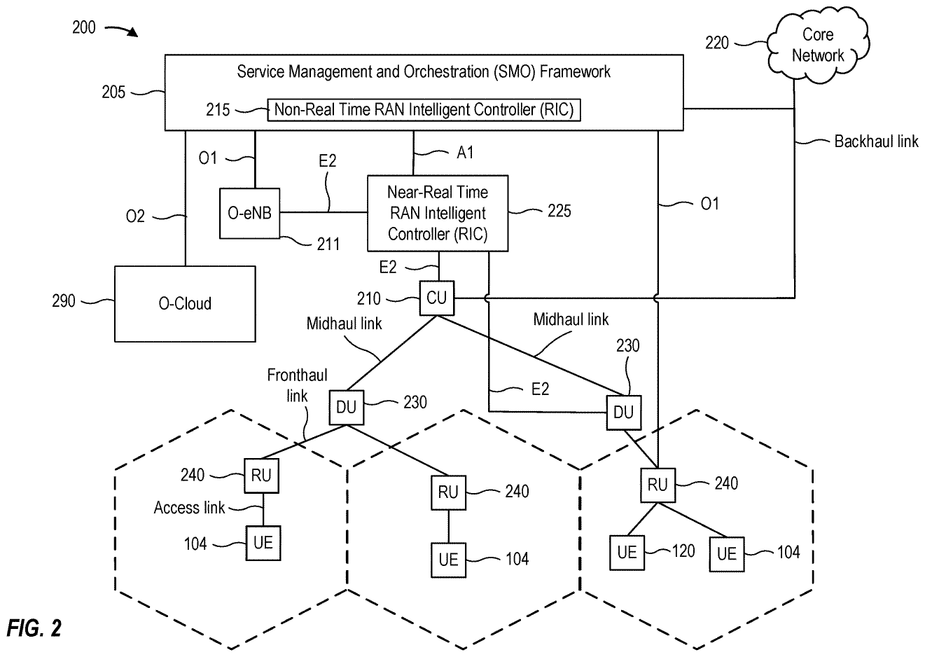

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a near-real time (near-RT) radio access network (RAN) intelligent controller (RIC), or a non-real time (non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC network 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the 3^{rd} Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting MBMS-related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC network 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a near-real time (near-RT) RAN intelligent controller (RIC) 225 via an E2 link, or a non-real time (non-RT) RIC 215 associated with a service management and orchestration (SMO) framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage specifications which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence/machine learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

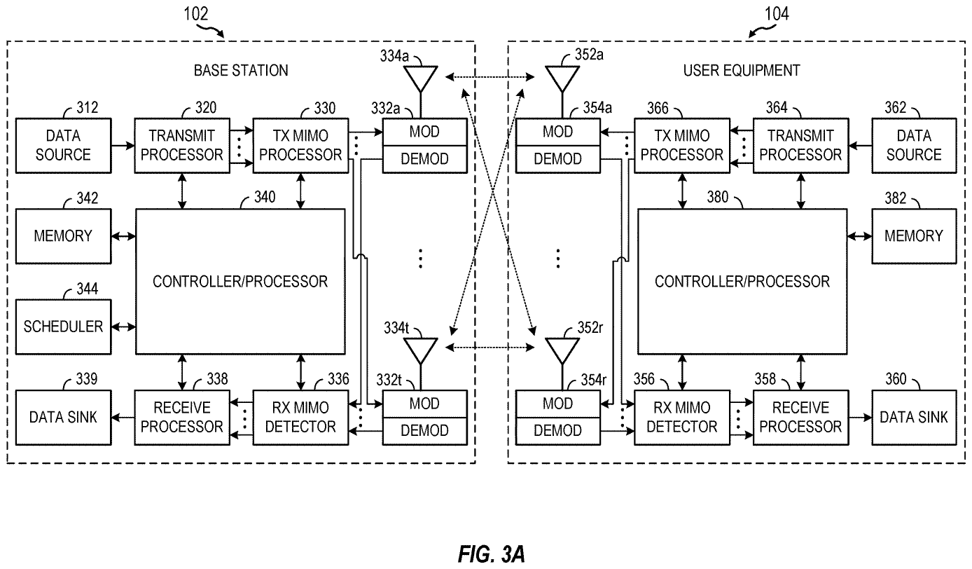

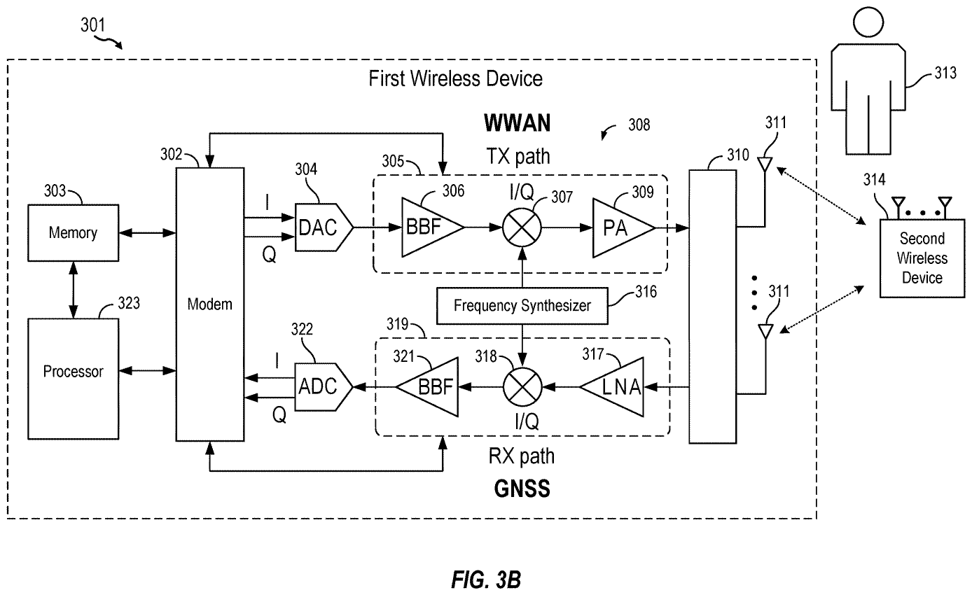

FIG. 3A depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the physical uplink shared channel (PUSCH)) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for single-carrier frequency division multiplexing (SC-FDM)), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, receive (RX) MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

FIG. 3B illustrates example components of the first wireless device 301, which may be used to communicate with any of the second wireless devices 314, in some cases, in proximity to human tissue as represented by the human 313.

The first wireless device 301 may be, or may include, a chip, system on chip (SoC), chipset, package or device that includes one or more modems 302. In some cases, the modem(s) 302 may include, for example, any of a WWAN modem (e.g., a modem configured to communicate via E-UTRA and/or 5G NR standards), a wireless local area network (WLAN) modem (e.g., a modem configured to communicate via 802.11 standards), a Bluetooth modem, a non-terrestrial network (NTN) modem, a global navigation satellite system (GNSS) modem, etc. In certain aspects, the first wireless device 301 also includes one or more radios (collectively “the radio 308”). In some aspects, the first wireless device 301 further includes one or more processors, processing blocks or processing elements (collectively “the processor 323”) and one or more memory blocks or elements (collectively “the memory 303”).

In certain aspects, the processor 323 may include a processor representative of an application processor that generates information (e.g., application data such as content requests) for transmission and/or receives information (e.g., requested content) via the modem 302. In some cases, the processor 323 may include a microprocessor associated with the modem 302, which may process any of certain protocol stack layers associated with a radio access technology (RAT), such as a WWAN RAT (e.g., 5G, 4G, etc.) and/or a GNSS RAT. For example, the processor 323 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 302 (e.g., the WWAN modem) may be in communication with one or more of the other modems 302 (e.g., the WLAN modem, GNSS modem, and/or Bluetooth modem). For example, the processor 323 may be representative of at least one of the modems 302 in communication with one or more of the other modems 302.

The modem 302 may generally be configured to implement a physical (PHY) layer. For example, the modem 302 may be configured to modulate packets and to output the modulated packets to the radio 308 for transmission over a wireless medium. The modem 302 is similarly configured to obtain modulated packets received by the radio 250 and to demodulate the packets to provide demodulated packets. In addition to a modulator and a demodulator, the modem 302 may further include digital signal processing (DSP) circuitry, automatic gain control (AGC), a coder, a decoder, a multiplexer and a demultiplexer (not shown).

As an example, while in a transmission mode, the modem 302 may obtain data from the processor 323. The data obtained from the processor 323 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 304. In certain aspects involving beamforming, the modulated symbols in the respective spatial streams may be precoded via a steering matrix prior to provision to the IFFT block.

The modem 302 may be coupled to the radio 308 including a transmit (TX) path 305 (also known as a transmit chain) for transmitting signals via one or more antennas 311 and a receive (RX) path 319 (also known as a receive chain) for receiving signals via the antennas 311. For example, in some cases, the TX path 305 may be used to transmit an uplink transmission associated with a first RAT radio (e.g., WWAN RAT radio) while the RX path 319 may be used for receive signals associated with a second RAT radio (e.g., GNSS radio). When the TX path 305 and the RX path 319 share an antenna 311, the paths may be connected with the antenna via an interface 310, which may include any of various suitable RF devices, such as a switch, a duplexer, a diplexer, a multiplexer, and the like. As an example, the modem 302 may output digital in-phase (I) and/or quadrature (Q) baseband signals representative of the respective symbols to the DAC 304.

Receiving I or Q baseband analog signals from the DAC 304, the TX path 305 may include a baseband filter (BBF) 306, a mixer 307 (which may include one or several mixers), and a power amplifier (PA) 309. The BBF 306 filters the baseband signals received from the DAC 304, and the mixer 307 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 307 are typically RF signals, which may be amplified by the PA 309 before transmission by the antenna 311. The antennas 311 may emit RF signals, which may be received at the second wireless device 314. While one mixer 307 is illustrated, several mixers may be used to upconvert the filtered baseband signals to one or more intermediate frequencies and to thereafter upconvert the intermediate frequency signals to a frequency for transmission.

The RX path 319 may include a low noise amplifier (LNA) 317, a mixer 318 (which may include one or several mixers), and a baseband filter (BBF) 321. RF signals received via the antenna 311 (e.g., from the second wireless device 314) may be amplified by the LNA 317, and the mixer 318 mixes the amplified RF signals with a receive local oscillator (LO) signal to convert the RF signal to a baseband frequency (e.g., downconvert). The baseband signals output by the mixer 318 may be filtered by the BBF 321 before being converted by an analog-to-digital converter (ADC) 322 to digital I or Q signals for digital signal processing. The modem 302 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 316, which may be buffered or amplified by an amplifier (not shown) before being mixed with the baseband signals in the mixer 307. Similarly, the receive LO frequency may be produced by the frequency synthesizer 316, which may be buffered or amplified by an amplifier (not shown) before being mixed with the RF signals in the mixer 318. Separate frequency synthesizers may be used for the TX path 305 and the RX path 319.

While in a reception mode, the modem 302 may obtain digitally converted signals via the ADC 322 and RX path 319. As an example, in the modem 302, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 323) for processing, evaluation, or interpretation.

The processor 323 and/or modem 302 may control the transmission of signals via the TX path 305 and/or reception of signals via the RX path 319. In some aspects, the processor 323 and/or modem 302 may be configured to perform various operations, such as those associated with any of the methods described herein. The processor 323 and/or the modem 302 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 323 may be integrated with (incorporated in and/or shared with) the modem 302, such as the RF exposure manager 106, a microcontroller, a microprocessor, a baseband processor, a medium access control (MAC) processor, a digital signal processor, etc. For example, the processor 323 may be representative of a co-processor (e.g., a microprocessor) associated with the modem 302, and the modem 302 may be representative of an ASIC including the baseband processor, MAC processor, DSP, and/or neural network processor. The memory 303 may store data and program codes (e.g., computer-readable instructions) for performing wireless communications as described herein. The memory 303 may be external to the processor 323 and/or the modem 302 (as illustrated) and/or incorporated therein. In certain cases, the RF exposure manager 106 (as implemented via the processor 323 and/or modem 302) may determine a transmit power (e.g., corresponding to certain levels of gain(s) applied to the TX path 305 including the BBF 306, the mixer 307, and/or the PA 309) that complies with an RF exposure limit set by country-specific regulations and/or international guidelines (e.g., International Commission on Non-Ionizing Radiation Protection (ICNIRP) guidelines) as described herein.

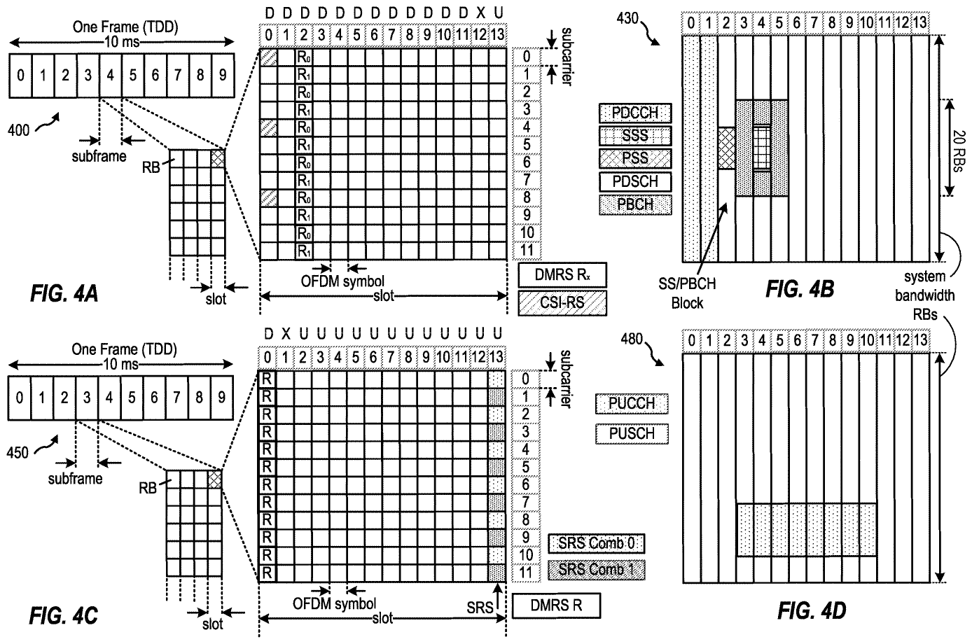

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3A). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3A) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in some configurations. The PUCCH carries uplink control information (UCI), such as scheduling requests, a channel quality indicator (CQI), a precoding matrix indicator (PMI), a rank indicator (RI), and HARQ acknowledgement (ACK)/negative acknowledgement (NACK) feedback. The PUSCH carries data, and may additionally be used to carry a buffer status report (BSR), a power headroom report (PHR), and/or UCI.

### Aspects Related to Dynamic GNSS Blanking

As noted above, a UE may include multiple radios for different types of communications. For example, the UE may include a wireless wide area network (WWAN) for communicating (e.g., transmitting/receiving) transmissions, such as 5G transmission, 4G transmission, and the like. In some cases, the UE may also include a global navigation satellite system (GNSS) radio used for receiving positioning data for the GNSS. As used herein, the term “GNSS” generally refers to any satellite constellation that provides positioning, navigation, and timing (PNT) services on a global or regional basis, including global positioning system (GPS), global navigation satellite system (GLONASS), BeiDou navigation satellite system, Galileo satellite system, and other similar navigation satellite systems.

In some cases, GNSS radios may operate in a layer one (L1) frequency band (e.g., 1575.42 megahertz (MHz)). WWAN networks, on the other hand, may operate in various frequency bands, depending on the technology and/or region. For example, 4G long-term evolution (LTE) networks commonly use frequency bands around 700 MHz, 850 MHz, 1800 MHz, 1900 MHz, and 2100 MHz, etc. Similarly, 5G new radio (NR) networks commonly use frequency bands around 600 MHz, 700 MHz, 850 MHz, 900 MHz, 1.8 gigahertz (GHz), 2.1 GHZ, 2.3 GHZ, 2.5 GHZ, etc.

In some cases, when the GNSS radio and the WWAN radio of a UE are located in close proximity to each other, WWAN transmissions emitted by the WWAN radio may have the potential to cause different types of interference that negatively affect the relatively weak GNSS transmissions received by the GNSS radio. For example, this interference may result in performance degradation of the GNSS radio or even a complete loss of a GNSS signal lock, known as a desense, which may result in the UE obtaining inaccurate positioning data. In some cases, the interference that may cause GNSS radio desense may include out-of-band (OOB) interference, intermodulation distortion (IMD), and/or harmonic interference. OOB interference refers to interference originating from frequencies outside a GNSS frequency band(s) that are capable of affecting GNSS radio performance. IMD may occur when two or more WWAN signals transmitted at different frequencies interact within a nonlinear component of the UE, such as an amplifier or mixer, causing new unwanted frequencies to be generated within the GNSS frequency band.

In some cases, to help reduce interference caused to GNSS transmission received by a UE, the UE may employ a technique known as GNSS blanking. GNSS blanking aims to mitigate the impact of such interference by temporarily stopping or suppressing the reception of GNSS transmissions during periods when the interfering transmissions (e.g., WWAN transmissions) are present. For example, when interference is detected or predicted, the GNSS radio may activate a blanking mechanism that prevents the GNSS radio from processing and utilizing GNSS reception for a specific period. The blanking period typically coincides with the duration of the interference event or a predetermined time interval based on the nature of the interference source. During the blanking period, the GNSS radio may still track the satellite transmissions but may not use these transmissions for positioning, navigation, or timing purposes. This prevents the interference from affecting the positioning measurements or calculations performed by the UE, ensuring that the UE does not rely on potentially corrupted GNSS data during interference events.

Different types of GNSS blanking may be employed by the UE to help mitigate the effects of interference on GNSS transmission received by the UE. These different types of GNSS blanking may include, for example, time division duplexing (TDD) blanking, in-device coexistence (IDC) blanking, and multi-tone jamming (MTJ) frequency division duplexing (FDD) blanking. TDD blanking may involve blanking signals received using the GNSS radio whenever the WWAN radio is actively transmitting, irrespective of a transmission power, transmission bandwidth, or resource block (RB) configuration of the WWAN transmissions.

Regarding IDC and MTJ blanking, uplink carrier aggregation (ULCA) or E-UTRAN New Radio—Dual Connectivity (ENDC) transmissions may generate intermodulation (IMD) when the UE transmits UL transmissions simultaneously on a primary cell (PCell) and a secondary cell (SCell). In some cases, when these uplink transmissions fall within the GNSS band, the IMD caused by these uplink transmission may distort GNSS signals and cause a large positioning error. Two mitigation techniques may be utilized. For example, IDC may be used for low-order IMD, which is typically strong. For higher-order IMD, MTJ blanking may be used.

For IDC blanking, during an emergency call, because positioning detection is a high priority, and to prevent any adverse effect on GNSS performance, a secondary WWAN signal associated with the SCell may be dropped at the UE which may result in WWAN data rate reduction. During a non-emergency call, if the amount of Pcell UL (PCC WWAN Up-Link)+Scell UL (SCC WWAN Up-Link) is less than 50% of the time, GNSS blanking may be considered. However, if the amount of Pcell UL and Scell UL is more than 50% of the time, the negative impact on GNSS performance is very significant, and GNSS blanking may not help to mitigate the impact to an acceptable level. Therefore, secondary WWAN drop is considered, which may result in a reduction in WWAN UL data rate.

In some cases, MTJ blanking may be used for periodic interference that may have lower interference levels, which may cause false detection.

While GNSS blanking is effective in reducing interference and improving performance of the UE's GNSS radio, current GNSS blanking techniques are typically applied statically and may not take into account actual antenna isolation between the GNSS radio and WWAN radio, WWAN transmission bandwidth, or active WWAN transmission power, which may lead to inefficiencies when applying GNSS blanking.

For example, for OOB-based desense or interference, the GNSS radio of the UE may be configured to perform GNSS blanking for all WWAN channels, WWAN transmission powers, WWAN transmission bandwidths, and WWAN transmission frequencies. In other words, for OOB-based desense or interference, GNSS blanking may be performed regardless of the particular WWAN channel over which an interfering WWAN transmission is to be communicated, the transmission power level of the interfering WWAN transmission, the transmission bandwidth of the interfering WWAN transmission, or the transmission frequency of the interfering WWAN transmission. Such GNSS blanking techniques may be inefficient and unnecessary in certain scenarios.

For example, there may be scenarios in which, while a WWAN transmission is scheduled to be communicated at a same time as a reception of a GNSS transmission, this WWAN transmission may be communicated using a WWAN channel, transmission power level, transmission bandwidth, or transmission frequency that may not produce a level of OOB noise that would significantly interfere with the GNSS transmission. However, in these scenarios, the UE may still perform GNSS blanking, even though GNSS blanking is unnecessary since the WWAN transmission will not significantly interfere with the GNSS transmission.

Similarly, for IMD-based or harmonics-based desense or interference, while GNSS blanking may be performed depending on the particular WWAN channel over which the interfering WWAN transmission is to be communicated, this GNSS blanking may be performed regardless of all transmission power levels that may be used to communicate the interfering WWAN transmission. As a result, there may be certain scenarios in which, while a WWAN transmission is scheduled to be communicated at a same time as a reception of a GNSS transmission, this WWAN transmission may be communicated using a transmission power level that may not produce a level of IMD-based or harmonics-based interference that would significantly interfere with the GNSS transmission. However, as noted above, using current GNSS blanking techniques, the UE may still perform the GNSS blanking even though the GNSS blanking is unnecessary since the transmission power level of the WWAN transmission will not result in significant interference with the GNSS transmission.

As noted above, current static GNSS blanking techniques may lead to the UE performing GNSS blanking in unnecessary scenarios, which may result in an unnecessary reduction in the accuracy of positioning measurements performed by the UE and an increase in positioning errors and, in some cases, may result in a reduction in WWAN UL data rate due to SCell drop. Moreover, inaccurate position data may have significant negative implications for applications such as navigation, timing synchronization, and geolocation-based services.

Accordingly, aspects of the present disclosure provide techniques for dynamic GNSS blanking. In some cases, these techniques may allow a UE to decide whether to perform GNSS blanking or refrain from performing GNSS blanking when a WWAN-based uplink (UL) transmission is to be sent during an operating session of a GNSS radio (e.g., during a time at which the GNSS radio is schedule to receive a GNSS transmission). For example, in some cases, when the UE determines that one or more thresholds associated with the UL transmission, such as a power threshold, an IMD threshold, and/or an antenna isolation threshold, are satisfied, the UE may be configured to perform a GNSS blanking operation on the signals received using a GNSS radio. Also, in an IDC blanking scenario in a non-emergency call, when one or more thresholds associated with the UL transmission (such as IMD threshold and antenna isolation threshold) are satisfied, instead of dropping SCC completely (e.g., which would cause a reduction in UL data rate), the power back-off can be applied to SCC UL to the extent that the IMD generated by PCC and SCC does not exceed the IMD thresholds any more. Thus, GNSS performance would not be affected. However, when the UE determines that the one or more thresholds associated with the UL transmission are not satisfied, the UE may instead be configured to refrain from performing the GNSS blanking operation on the signals received using a GNSS radio.

In some cases, scenarios in which the one or more thresholds are not satisfied may include scenarios in which GNSS blanking is unnecessary because the UL transmission is not expected to cause a significant amount of interference to the signals received using the GNSS radio. Accordingly, by refraining from performing the GNSS blanking operation in these scenarios, the UE may avoid the unnecessary reduction in the accuracy of positioning measurements and potential increase in position errors. In other words, by refraining from performing the GNSS blanking operation in these scenarios, the UE may be able to improve performance of the GNSS radio and the accuracy of GNSS measurements, thereby avoiding negative effects to navigation, timing synchronization, and geolocation-based services.

### Example Operations for Dynamic GNSS Blanking

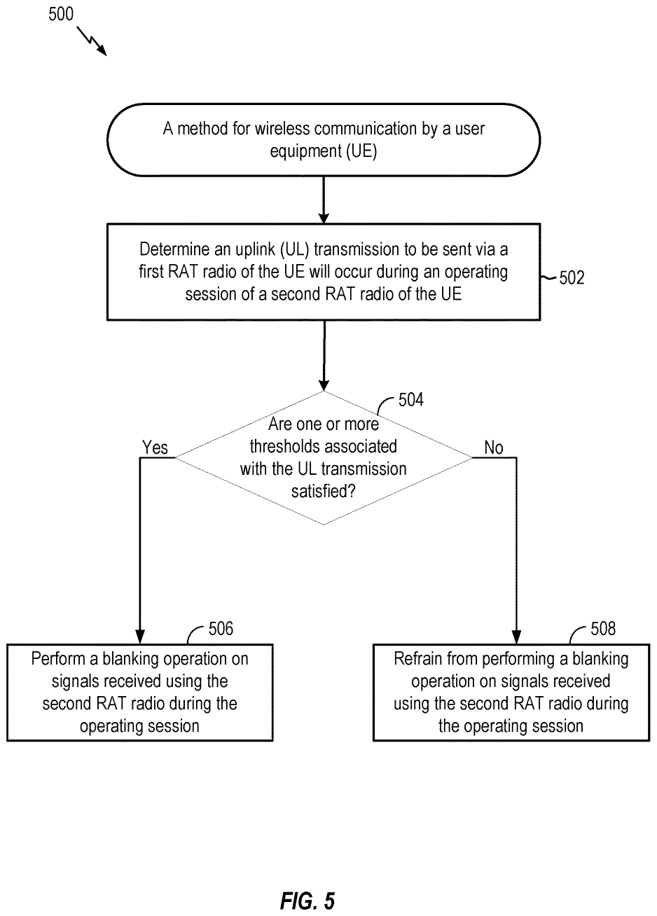

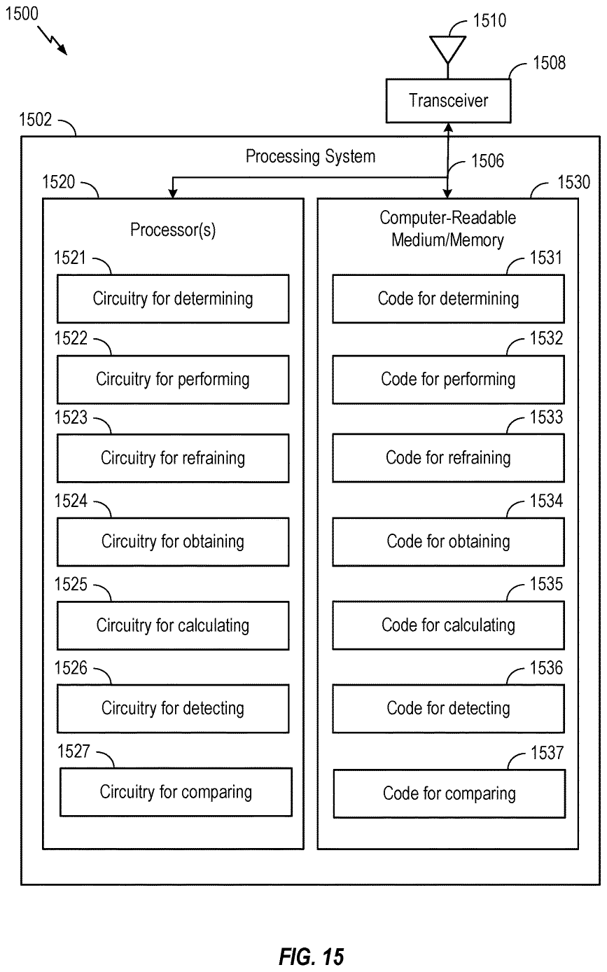

FIG. 5 depicts a process flow including operations 500 for communications in a network. In some aspects, operations 500, or any aspect related thereto, may be performed by an apparatus, such as communications device 1500 of FIG. 15, which includes various components operable, configured, or adapted to perform the operations 500. Communications device 1500 is described below in further detail. Note that FIG. 5 is just one example of a method, and other methods including fewer, additional, or alternative processes are possible consistent with this disclosure.

In some aspects, the communications device 1500 configured to perform the operations 500 may be a user equipment (UE), such as the UE 104 described with respect to FIGS. 1 and 3A. In some aspects, the UE may include multiple radios that permit the UE to communicate with multiple different types of radio access technologies (RATs), such as a first RAT radio and a second RAT radio. In some cases, the first RAT radio may be a WWAN radio, such as a 5G radio, a 4G radio, or the like. In some cases, the second RAT radio may be a GNSS radio, such as a global positioning system (GPS) radio or a global navigation satellite system (GLONASS) radio.

As shown, operations 500 begin at 502 with the UE determining an uplink (UL) transmission to be sent via the first RAT radio of the UE will occur during an operating session of a second RAT radio of the UE. In some cases, the UL transmission may be scheduled to be sent using a first antenna associated with the first RAT radio. In some cases, the operating session of the second RAT radio may comprise a period of time in which the UE is scheduled to receive transmissions, such as GNSS transmissions from a satellite, using a second antenna associated with the second RAT radio.

Thereafter, at 504, the UE determines if one or more thresholds associated with the UL transmission are satisfied. Additional details regarding the one or more thresholds are described in greater detail below.

As shown at 506, when the one or more thresholds associated with the UL transmission are satisfied, the UE may perform a blanking operation on signals received using the second RAT radio during the operating session. In some cases, the blanking operation may comprise at least one of TDD blanking, IDC blanking, or MTJ FDD blanking, as described above.

In contrast, as shown at 508, when the one or more thresholds associated with the UL transmission are not satisfied, the UE refrains from performing the blanking operation on the signals received using the second RAT radio during the operating session. In some cases, when the UE refrains from performing the blanking operation, the UE may be configured to process and demodulate signals received using the second RAT radio during the operating session, even though the UL transmission will also be sent during the operating session. In other words, even though the UL transmission will also be sent during the operating session and because the one or more thresholds associated with the UL transmission are not satisfied, the UE may still be configured to use the signals received using the second RAT radio for positioning purposes (e.g., determining a position of the UE) rather than disregarding or blanking these signals.

As can be seen at 506 and 508, the UE may be configured to dynamically perform the blanking operation based on whether one or more thresholds associated with the UL transmission are satisfied. In other words, the UE may be configured to dynamically enable and disable the blanking operation associated with the second RAT radio based on the one or more thresholds associated with the UL transmission that is to be sent via the first RAT radio of the UE. In some aspects, the one or more thresholds and the dynamic blanking operation may be based on or may depend on different criteria, such as at least one of a transmission bandwidth of the UL transmission, a transmission channel of the UL transmission, a transmit power of the UL transmission, or an antenna isolation between a first antenna associated with the first RAT radio for transmitting the UL transmission and a second antenna associated with the second RAT radio for receiving the signals during the operating session. These different criteria may be taken into account when determining the one or more thresholds for different interference or noise scenarios that have the potential to negatively affect the signals received using the second RAT radio during the operating session.

For example, for scenarios involving OOB noise/harmonics, the one or more thresholds may comprise a power threshold associated with the UL transmission. In such cases, the UE may perform the blanking operation at 506 when a transmission power of the UL transmission is greater than or equal to the power threshold. Alternatively, the UE may refrain from performing the blanking operation at 508 when the transmission power of the UL transmission is less than the power threshold.

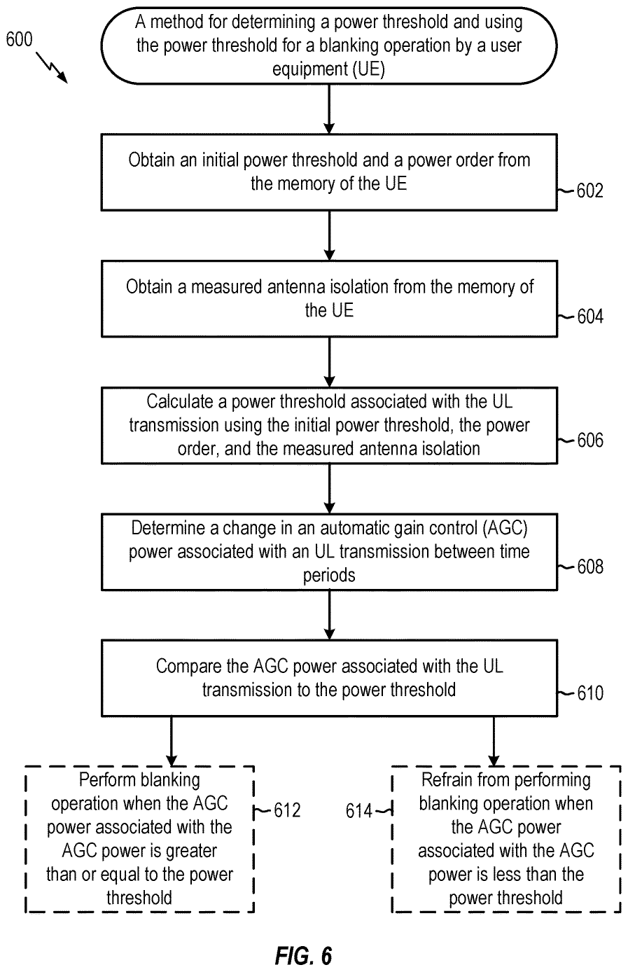

In some cases, the UE may determine the power threshold based on an initial power threshold, a power order, and an antenna isolation between the first antenna associated with the first RAT radio and the second antenna associated with the second RAT radio. Operations 600 for determining the power threshold and using the power threshold for performing the blanking operation are illustrated in FIG. 6.

As shown, operations 600 begin at 602 with the UE obtaining an initial power threshold and a power order from the memory of the UE. In some cases, the initial power threshold and power order may comprise static values stored in the memory of the UE and may be based on hardware performance of the UE, such as a power amplifier of the UE. At 604, the UE may also obtain a measured antenna isolation from the memory of the UE. In some cases, the measured antenna isolation may be a static value that is determined based on an antenna isolation characterization tool and stored in the memory of the UE.

Thereafter, at 606 the UE may calculate the power threshold associated with the UL transmission using the initial power threshold (Pₜₕ), an OOB level at initial power threshold (OOBNₜₕ), a maximum power (Pₘₐₓ), an OOB level at Pmax (OOBNₘₐₓ), the measured antenna isolation (ANT_Iso), and a reference antenna isolation (ANT_Iso_{ref}). For example, the UE may calculate the power threshold (P_{Threshold}) in decibel milliwatts (dBm) according to Equations 1 and 2, below:

$${Power}_{order} = \frac{( {P}_{t h} - {P}_{max} )}{( {OOB}_{t h} - {OOB}_{p max} )} \qquad ( 1 )$$

$${P}_{threshold} = {P}_{th} + Power\_Order * ( {ANT}_{Iso} - {ANT\_Iso}_{ref} ) \qquad ( 2 )$$

In some cases, the UE may use the power threshold to determine whether to perform the blanking operation on the signals received using the second RAT radio whenever a change in an automatic gain control (AGC) power associated with the UL transmission occurs between time periods. For example, at 608, the UE may determine a change in the AGC power associated with the UL transmission between time periods. At 610, based on the determined change, the UE may compare the AGC power associated with the UL transmission to the power threshold. In some cases, the change in the AGC power associated with the UL transmission may occur between time slots (e.g., for 4G LTE-based communications) or symbols (e.g., for 5G NR-based communications).

Accordingly, at 612 (e.g., which may correspond to 506 in FIG. 5), the UE may perform the blanking operation on the signals received using the second RAT radio during the operating session when the AGC power associated with the UL power is greater than or equal to the power threshold. Conversely, at 614 (e.g., which may correspond to 508 in FIG. 5), the UE may refrain from performing the blanking operation on the signals received using the second RAT radio during the operating session when the AGC power associated with the UL power is less than the power threshold.

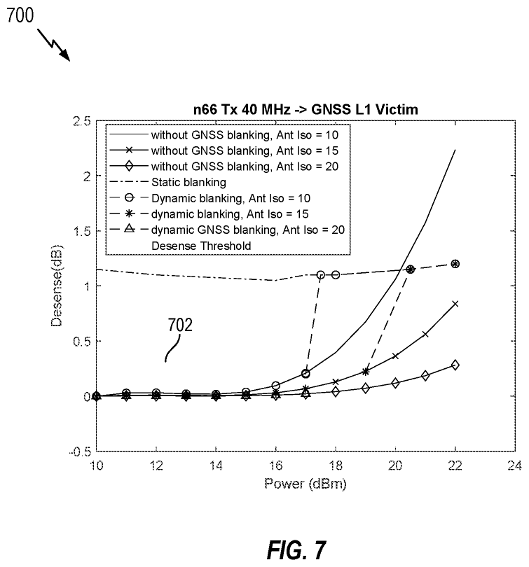

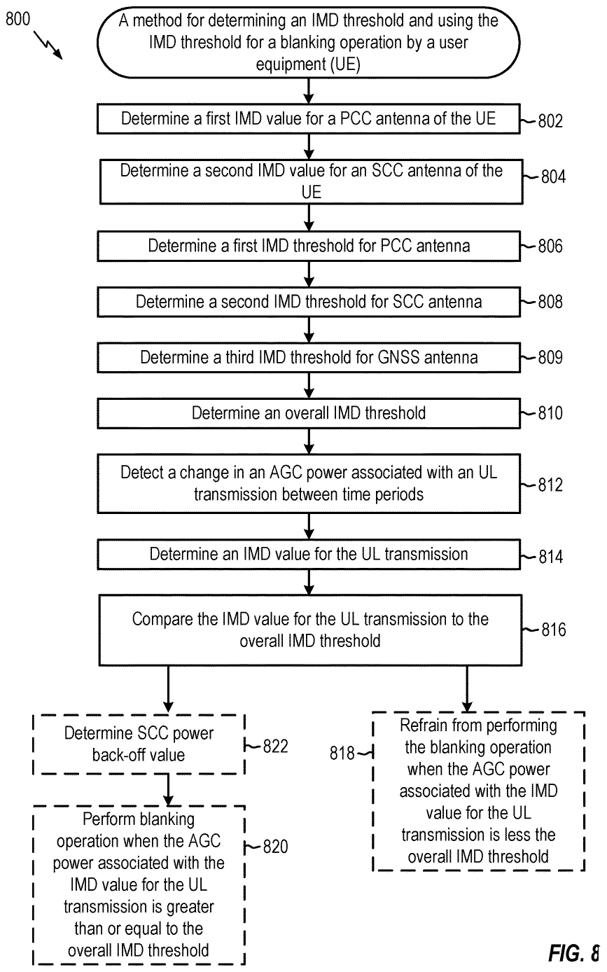

FIG. 7 includes a graph 700 illustrating resulting GNSS desense due to OOB noise on a particular frequency band (e.g., 5G NR frequency band n66) for different transmit powers associated with the UL transmission and different antenna isolations between the first antenna associated with the first RAT radio (e.g., WWAN RAT radio) and the second antenna associated with the second RAT radio (e.g., GNSS RAT radio). In some cases, the UE may be configured to perform the blanking operation when the GNSS desense due to OOB noise associated with the UL transmission is greater than or equal to a GNSS desense limit 702, such as 0.3 dB, which may occur at different threshold powers for different antenna isolations.

For example, as shown, the graph 700 includes the GNSS desense curves at the absence of any GNSS blanking either static or dynamic for three different antenna isolations, such as a 10 dB antenna isolation, a 15 dB antenna isolation, and a 20 dB antenna isolation across n66 UL power range from 10 dBm to 22 dBm. The graph 700 also shows that once the static GNSS blanking is applied, the GNSS desense is capped to about 1 dB desense for all power and ANT isolation conditions. This method can improve the GNSS desense at some high power ranges with low ANT isolation (e.g., above 20 dBm with 10 dB ANT isolation); however, at the conditions where thresholds are not satisfied and the GNSS desense is below 0.3 dB threshold, the static GNSS blanking negatively impacts performance.

Finally, the graph 700 illustrates that once the dynamic GNSS blanking is applied, for the 10 dB antenna isolation, the UE may be configured to perform the blanking operation only when the transmit power associated with the UL transmission is greater than or equal to a threshold of approximately 17.5 dBm at which point the GNSS desense is equal to the GNSS desense limit 702. In contrast, the UE may refrain from performing the blanking operation when the antenna isolation is 10 dB and when the transmit power associated with the UL transmission is less than the approximately 17.5 dBm threshold since, at this point, the GNSS desense is less than the GNSS desense limit 702.

Similarly, for the 15 dB antenna isolation, the UE may be configured to perform the blanking operation when the transmit power associated with the UL transmission is greater than or equal to a threshold of approximately 20 dBm, at which point the GNSS desense is equal to the GNSS desense limit 702. In contrast, the UE may refrain from performing the blanking operation when the antenna isolation is 15 dB and when the transmit power associated with the UL transmission is less than the approximately 20 dBm threshold since, at this point, the GNSS desense is less than the GNSS desense limit 702.

In contrast, when the antenna isolation is 20 dB, the UE may refrain from performing the blanking operation altogether since the GNSS desense remains below the GNSS desense limit 702 for all transmission powers associated with the UL transmission.

Accordingly, as can be seen in FIG. 7, the power threshold associated with the UL transmission may be based on the antenna isolation between the first antenna associated with the first RAT radio for the UL transmission and the second antenna associated with the second RAT radio for receiving the signals during the operating session. As such, the UE may be configured to perform the blanking operation on the signals received using the second RAT radio when the antenna isolation is less than or equal to an antenna isolation threshold (e.g., 20 dB), when certain other conditions are met, for example. In contrast, the UE may be configured to refrain from performing the blanking operation on the signals received using the second RAT radio when the antenna isolation is greater than the antenna isolation threshold (e.g., 20 dB).

As noted above, for scenarios involving OOB noise and/or harmonics, the one or more thresholds may comprise a power threshold associated with the UL transmission. In contrast, for IMD scenarios, the one or more thresholds may comprise an overall IMD threshold associated with the UL transmission. In such cases, the UE may perform the blanking operation at 506 of FIG. 5 when an IMD of the UL transmission is greater than or equal to the overall IMD threshold. Alternatively, the UE may refrain from performing the blanking operation at 508 of FIG. 5 when the IMD of the UL transmission is less than the overall IMD threshold.

In some cases, the overall IMD threshold associated with the UL transmission may be based on at least one of an antenna isolation between (1) the first antenna associated with the first RAT radio for transmitting the UL transmission and the second antenna associated with the second RAT radio for receiving the signals during the operating session or (2) a third antenna associated with the first RAT radio for transmitting the UL transmission and the second antenna associated with the second RAT radio. In some cases, the first antenna may be a primary component carrier (PCC) antenna of the UE for transmitting a PCC, and the third antenna may be a secondary component carrier (SCC) antenna of the UE for transmitting an SCC. Operations 800 for determining the IMD threshold and using the IMD threshold for performing a blanking operation are illustrated in FIG. 8.

As shown at 802 of FIG. 8, to determine the overall IMD threshold, the UE may determine a first IMD value for the PCC antenna of the UE. In some cases, the UE may determine the first IMD value for the PCC antenna based on an IMD of the PCC at a maximum transmit power of the PCC (e.g., IMD_PCCₚₘₐₓ), a power order associated with the PCC (e.g., m), the maximum transmit power of the PCC (e.g., PCCₚₘₐₓ), a power order associated with the SCC of the UE (e.g., n), a maximum transmit power of the SCC (e.g., SCCₚₘₐₓ), and a reference antenna isolation between the PCC antenna and an SCC antenna (e.g., Ref_PCC_SCC_ANT). For example, the UE may determine the first IMD value (e.g., IMD1) according to Equation 3, below. In some cases, the reference antenna isolation between the PCC antenna and an SCC antenna may be a static value and may be obtained from a memory of the UE.

$$IMD 1 = {IMD\_PCC}_{pmax} - m * {PCC}_{pmax} - n * ( {SCC}_{pmax} - Ref\_PCC \_SCC \_ANT ) \qquad ( 3 )$$

As shown at 804, the UE may also determine a second IMD value for the SCC antenna of the UE. In some cases, the UE may determine the second IMD value for the SCC antenna based on an IMD of the SCC at a maximum transmit power of the SCC (e.g., IMD_SCCₚₘₐₓ), the power order associated with the PCC (e.g., m), the maximum transmit power of the PCC (e.g., PCCₚₘₐₓ), a power order associated with the SCC of the UE (e.g., n), the maximum transmit power of the SCC (e.g., SCCₚₘₐₓ), and the reference antenna isolation between the reference PCC antenna and an SCC antenna (e.g., Ref_PCC_SCC_ANT). For example, the UE may determine the second IMD value (e.g., IMD2) according to Equation 4 below:

$$IMD 2 = {IMD\_SCC}_{pmax} - n * {SCC}_{pmax} - m * ( {PCC}_{pmax} - Ref\_PCC \_SCC \_ANT ) \qquad ( 4 )$$

Thereafter, at 806, the UE may determine a first IMD threshold (IMD_{threshPCC}) in dBm based on the first IMD value (IMD1), the power order associated with the SCC (e.g., n), an antenna isolation between the PCC antenna and the SCC antenna (e.g., ANT_Iso_{[PCC-SCC]}), and an antenna isolation between the PCC antenna and the GNSS antenna (e.g., ANT_Iso_{[PCC-GNSS]}), as shown in Equation 5, below. In some cases, the antenna isolation between the PCC antenna (e.g., first antenna) and the GNSS antenna (e.g., second antenna) may be a static value and obtained from a memory of the UE.

$${IMD}_{threshPCC} = IMD 1 - n * {ANT\_Iso}_{[ PCC - SCC ]} - {ANT\_Iso}_{[ PCC - GNSS ]} \qquad ( 5 )$$

At 808, the UE may also determine a second IMD threshold (IMD_{threshSCC}) in dBm based on the second IMD value (IMD2), the power order associated with the PCC (e.g., m), the antenna isolation between the PCC antenna and the SCC antenna (e.g., ANT_Iso_{[PCC-SCC]}), and an antenna isolation between the SCC antenna and the GNSS antenna (e.g., ANT_Iso_{[SCC-GNSS]}), as shown in Equation 6, below:

$${IMD}_{threshSCC} = IMD 2 - m * {ANT\_Iso}_{[ PCC - SCC ]} - {ANT\_Iso}_{[ SCC - GNSS ]} \qquad ( 6 )$$

In some cases, the antenna isolation between the SCC antenna and the GNSS antenna may be a static value and may be obtained from a memory of the UE.

As shown at 809, the UE may also determine a third IMD threshold for a GNSS path of the UE (IMD_{threshGNSS}). In some cases, the UE may determine the third IMD threshold for the GNSS antenna based on an IMD of the GNSS path when PCC and SCC operate at maximum transmit powers (e.g., IMD_GNSS_{Ref_pmax}) with reference antenna isolation assumed between PCC ANT and GNSS ANT, as well as SCC ANT and GNSS ANT, the maximum transmit power of the PCC (e.g., PCCₚₘₐₓ), the power order associated with the PCC (e.g., m), a maximum transmit power of the SCC (e.g., SCCₚₘₐₓ), the ANT isolation between PCC and GNSS (e.g., ANT_Iso_{PCC-GNSS}), reference ANT isolation between PCC and GNSS (e.g., Ref_PCC_GNSS_ANT), a power order associated with the SCC of the UE (e.g., n), the ANT isolation between SCC and GNSS (e.g., ANT_Iso_{SCC-GNSS}), and reference ANT isolation between SCC and GNSS (e.g., Ref_SCC_GNSS_ANT). For example, the UE may determine the third IMD value (e.g., IMD_{threshGNSS}) according to Equation 7 below:

$${IMD}_{threshGNSS} = {IMD\_GNSS}_{REF \_ pmax} - m * ( P C {C}_{pmax} + {ANT\_Iso}_{PCC - GNSS} - Ref\_PCC \_GNSS \_ANT ) - n * ( {SCC}_{pmax} + {ANT\_Iso}_{SCC} - Ref\_SCC \_GNSS \_ANT ) \qquad ( 7 )$$

Thereafter, at 810, the UE may determine the overall IMD threshold (e.g., IMD_{overall_thresh}) in dBm based on the PCC path's IMD threshold (e.g., IMD_{threshPCC}), the SCC path's IMD threshold (e.g., IMD_{threshSCC}), the GNSS receiver path's IMD threshold (e.g., IMD_{threshGNSS}), and a noise threshold (e.g., Nₜₕ), as shown in Equation 8 below:

$${IMD}_{overall \_ thresh} = {N}_{th} - 10 * {log}_{10} ( 1 {0}^{\frac{IMDthreshPCC}{10}} + 1 {0}^{\frac{IMDthreshSCC}{10}} + {10}^{\frac{IMDthreshGNSS}{10}} ) \qquad ( 8 )$$

In some cases, the UE may use the overall IMD threshold to determine whether to perform the blanking operation on the signals received using the second RAT radio whenever at least one of a change in a PCC AGC power associated with the UL transmission or a change in an SCC AGC power associated with the UL transmission occurs between time periods. For example, as shown at 812, the UE may detect a change in a PCC/SCC AGC power associated with the UL transmission between time periods (e.g., slots for 4G LTE-based communications or symbols for 5G NR-based communications). Thereafter, at 814 in response to the detected change in the AGC power, the UE may determine an IMD value for the UL transmission based on the power order associated with the PCC (e.g., m), a transmission power associated with the PCC (e.g., P_{PCC}), the power order associated with the SCC (e.g., n), and a transmission power associated with the SCC (e.g., P_{SCC}), as shown in Equation 9, below:

$$IMD = m * {P}_{PCC} + n * {P}_{SCC} \qquad ( 9 )$$

At 816, the UE may then compare the IMD value for the UL transmission to the overall IMD threshold. As shown at 818 (e.g., corresponding to 508 in FIG. 5), the UE may refrain from performing the blanking operation on the signals received using the second RAT radio during the operating session when, based on the comparison, the IMD value is less than the overall IMD threshold.

Conversely, as shown at 820 (e.g., corresponding to 506 in FIG. 5), the UE may perform the blanking operation on the signals received using the second RAT radio during the operating session when, based on the comparison, the IMD value is greater than or equal to the overall IMD threshold.

In some cases, the blanking operation may optionally be performed at 820 in a time division multiplexing (TDM) manner along with applying an SCC power back-off value to uplink (UL) transmissions associated with the third antenna (e.g., the SCC antenna). For example, for the IDC blanking scenario described above in a non-emergency call, when the IMD value is greater than or equal to the overall IMD threshold, the UE may be configured to perform the blanking operation for the second antenna (e.g., GNSS antenna) and the third antenna (e.g., SCC antenna) in a TDM manner rather than dropping the UL transmissions associated with the third antenna completely. For example, rather than dropping the UL transmissions associated with the third antenna completely, the UE may instead apply an SCC power back-off value (e.g., P_{SCC_BO}) to the UL transmissions, which may optionally be determined by the UE at 822 according to Equation 10, below. As shown in Equation 10, the SCC power back-off value (e.g., P_{SCC_BO}) may be determined based on the power order associated with the PCC (e.g., m), the transmission power associated with PCC (e.g., P_{PCC}), the power order associated with the SCC (e.g., n), and the overall IMD threshold (e.g., IMD_{overall_thresh}).

$${P}_{SCC \_ BO} = \frac{1}{n} * {IMD}_{{overall}_{thresh}} - \frac{m}{n} * {P}_{P C C} - 1 ( dBm ) \qquad ( 10 )$$

In some cases, the SCC power back-off value may result in an SCC transmission power at which the IMD value of PCC and SCC UL does not exceed the overall IMD threshold obtained from Equation 8. Applying the SCC power back-off value to the UL transmissions, may allow the UE to perform simultaneous WWAN PCC UL and SCC UL along with GNSS reception without penalizing the GNSS performance. Further, these techniques may avoid WWAN UL data rate reduction that may otherwise result in dropping of the SCC when performing IDC blanking.

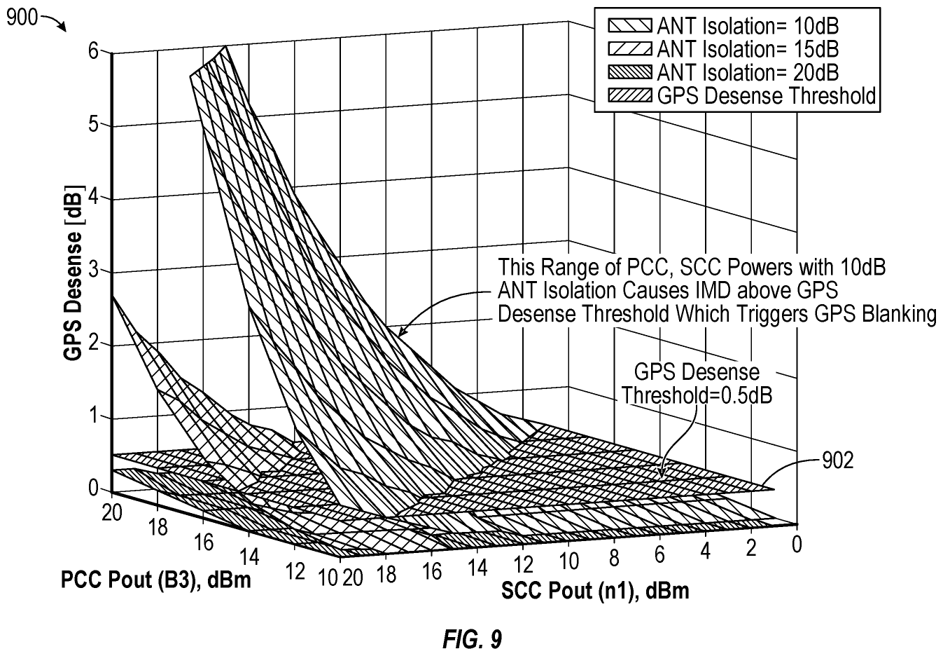

FIG. 9 includes a graph 900 illustrating resulting GNSS desense due to IMD for different PCC and SCC transmit powers associated with the UL transmission and different antenna isolations between the first antenna (e.g., PCC antenna), the second antenna (e.g., GNSS antenna), and third antenna (e.g., SCC antenna). In some cases, the UE may be configured to perform the blanking operation when the GNSS desense due to IMD associated with the UL transmission is greater than or equal to a GNSS desense limit 902, such as 0.5 dB. Note that the GNSS desense limit 902 may change based on the acceptable performance on different apparatuses. For example, as shown, for an antenna isolation of 20 dB, an IMD associated with the UL transmission may remain below an overall IMD threshold, resulting in a GNSS desense below the GNSS desense limit 902 for all PCC/SCC transmit powers of the UL transmission and allowing the UE to refrain from performing the blanking operation on the signals received using the second RAT radio. In contrast, for antenna isolations of 10 dB and 15 dB, certain combinations of the PCC and SCC transmit powers of the UL transmission may lead to the UL transmission having an IMD above the overall IMD threshold and resulting in a GNSS desense above the GNSS desense limit 902. In such cases, the UE may be configured to perform the blanking operation on the signals received using the second RAT radio for the combinations of PCC and SCC transmit powers that result in the UL transmission having an IMD above the GNSS desense limit 902.

Accordingly, as can be seen in FIG. 9, the IMD threshold associated with the UL transmission may be based on or may depend on the antenna isolation between the first antenna (e.g., PCC antenna) and the second antenna (e.g., GNSS antenna) and/or the antenna isolation between the first antenna (e.g., PCC antenna) and the third antenna (e.g., SCC antenna) and/or the antenna isolation between the third antenna (e.g., SCC antenna) and the second antenna (e.g., GNSS antenna). As a result, the UE may be configured to refrain from performing the blanking operation on the signals received using the second RAT radio when the antenna isolation is greater than an antenna isolation threshold (e.g., 20 dB). Conversely, in some cases, the UE may be configured to perform the blanking operation on the signals received using the second RAT radio when the antenna isolation is less than the antenna isolation threshold (e.g., 20 dB).

### Additional Details Regarding Dynamic GNSS Blanking

In some cases, the one or more thresholds may comprise a GNSS desense threshold. For example, if a GNSS desense resulting from the UL transmission to be sent via the first RAT radio is greater than or equal to the GNSS desense threshold, the UE may be configured to perform the blanking operation on the signals received using the second RAT radio during the operating session. However, if the GNSS desense resulting from the UL transmission to be sent via the first RAT radio is less than the GNSS threshold, the UE may be configured to refrain from performing the blanking operation on the signals received using the second RAT radio during the operating session. In some cases, the GNSS desense threshold may be 1 dB.

In static GNSS blanking, TDD blanking may be enabled for all PCC/SCC power ranges since the GNSS desense may exceed the GNSS threshold in a certain power range. In contrast, using the techniques described above for dynamic GNSS blanking may allow the UE to limit the blanking operation only in a bandwidth range in which GNSS desense exceeds the GNSS desense threshold.

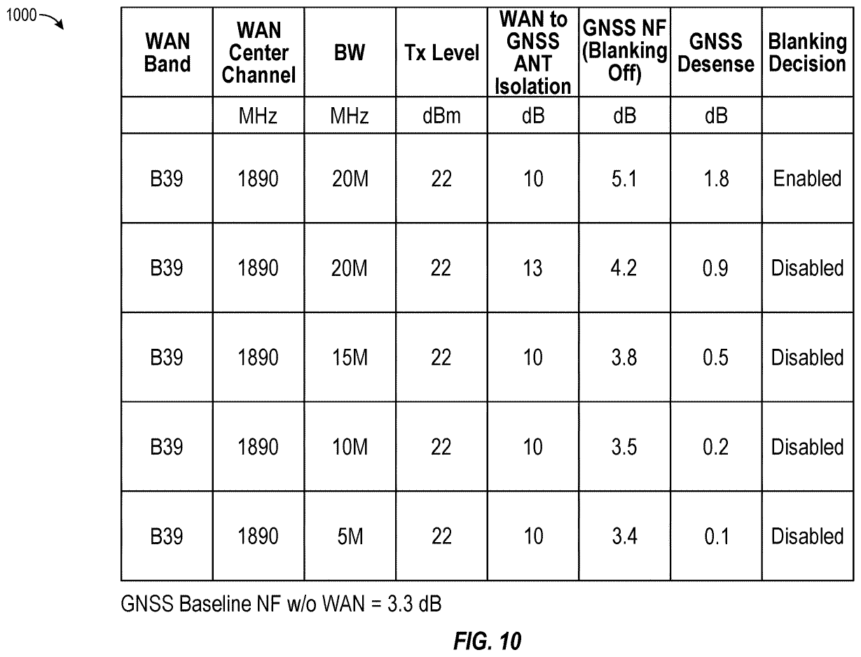

FIG. 10 includes a table 1000 illustrating an example in which the UE may limit the blanking operation only in a bandwidth range in which GNSS desense exceeds the GNSS desense threshold. For example, as shown, the blanking operation may be “enabled” (e.g., the UE performs the blanking operation at 506 in FIG. 5) for a bandwidth of 20 megahertz (MHz) when a transmission power of the UL transmission is 22 dBm and the antenna isolation between the first antenna associated with the first RAT radio and the second antenna associated with the second RAT radio is 10 dB, resulting in a GNSS desense of 1.8 dB above the 1 dB GNSS desense threshold. In contrast, when the antenna isolation is 13 dB, the blanking operation may be disabled (e.g., the UE refrains from performing the blanking operation at 508 in FIG. 5) for the 20 MHz bandwidth across all transmission power ranges. Similarly, the blanking operation may be disabled (e.g., the UE refrains from performing the blanking operation at 508 in FIG. 5) for other bandwidths (e.g., 15 MHz, 10 MHz, and 5 MHz) illustrated in table 1000 since the GNSS desense threshold for these bandwidths is not satisfied/exceeded assuming the same 22 dBm transmission power.

In some cases, an antenna isolation characterization tool may be used to correct a power threshold based on actual antenna isolation; otherwise 10 dB may be assumed as a default for antenna isolation as shown in FIG. 10.

As noted above, FIG. 10 illustrates a case in which the blanking operation may be limited depending on a particular bandwidth range. In some cases, whether or not the UE performs the blanking operation may be dependent on a particular frequency range. For example, in static GNSS blanking, TDD blanking may be enabled for all PCC/SCC power ranges since, in some power ranges, the GNSS desense exceeds the GNSS desense threshold. In contrast, using the techniques described above for dynamic GNSS blanking may allow the UE to limit the blanking operation only to a particular frequency range at which GNSS desense exceeds the GNSS desense threshold.

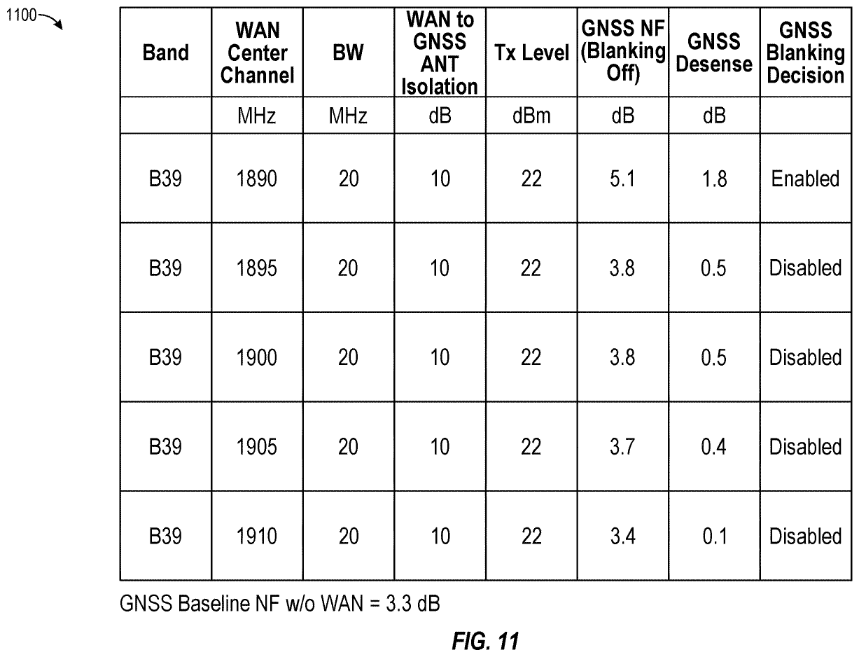

FIG. 11 includes a table 1100 illustrating an example in which the UE may limit the blanking operation only to a particular frequency range at which GNSS desense exceeds the GNSS desense threshold. For example, as shown, the blanking operation may be enabled (e.g., the UE performs the blanking operation at 506 in FIG. 5) for a frequency channel of 1890 MHz having a GNSS desense that is greater than the 1 dB GNSS desense threshold while the blanking operation may be disabled (e.g., the UE refrains from performing the blanking operation at 508 in FIG. 5) for other frequency channels (e.g., 1895 MHz, 1900 MHz, 1905 MHz, and 1910 MHz) illustrated in table 1100 since the GNSS desense threshold for these frequency channels is not satisfied/exceeded.

In some cases, whether or not the UE performs the blanking operation may be transmission power dependent. For example, in static GNSS blanking, TDD blanking may be enabled for all PCC/SCC power ranges since, in some power ranges, the GNSS desense exceeds the GNSS desense threshold. In contrast, using the techniques described above for dynamic GNSS blanking may allow the UE to limit the blanking operation only to a particular power range at which GNSS desense exceeds the GNSS desense threshold.

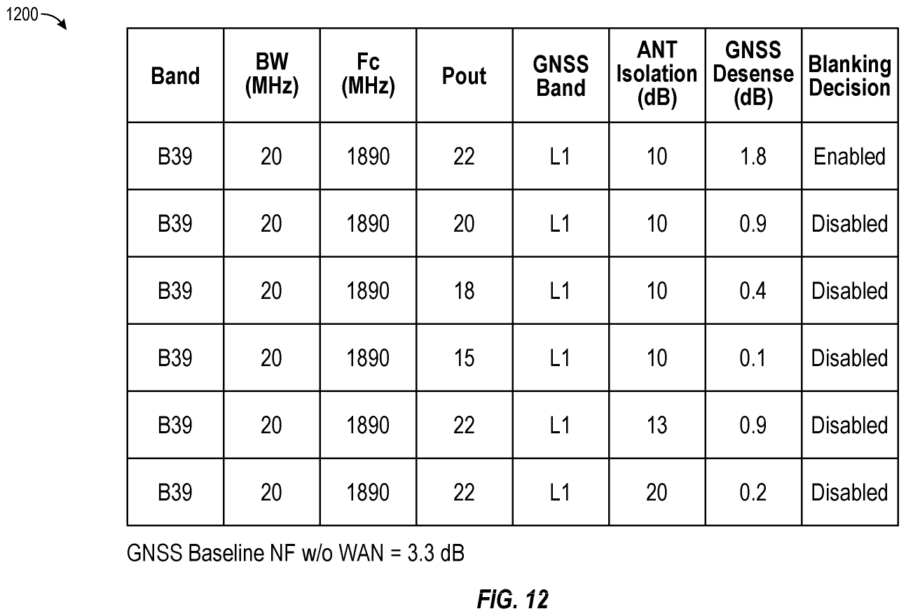

FIG. 12 includes a table 1200 illustrating an example in which the UE may limit the blanking operation only to a particular transmission power of the UL transmission at which GNSS desense exceeds the GNSS desense threshold. For example, as shown, the blanking operation may be enabled (e.g., the UE performs the blanking operation at 506 in FIG. 5) for frequency channel 1890 MHz having a transmission power (e.g., Pout) of 22 dBm and antenna isolation of 10 dB since a resulting GNSS desense is greater than the 1 dB GNSS desense threshold. In contrast, the blanking operation may be disabled (e.g., the UE refrains from performing the blanking operation at 508 in FIG. 5) for the other transmission powers of the 1890 MHz frequency channel and antenna isolations illustrated in table 1200 since the GNSS desense threshold for these transmission powers/antenna isolations is not satisfied/exceeded.

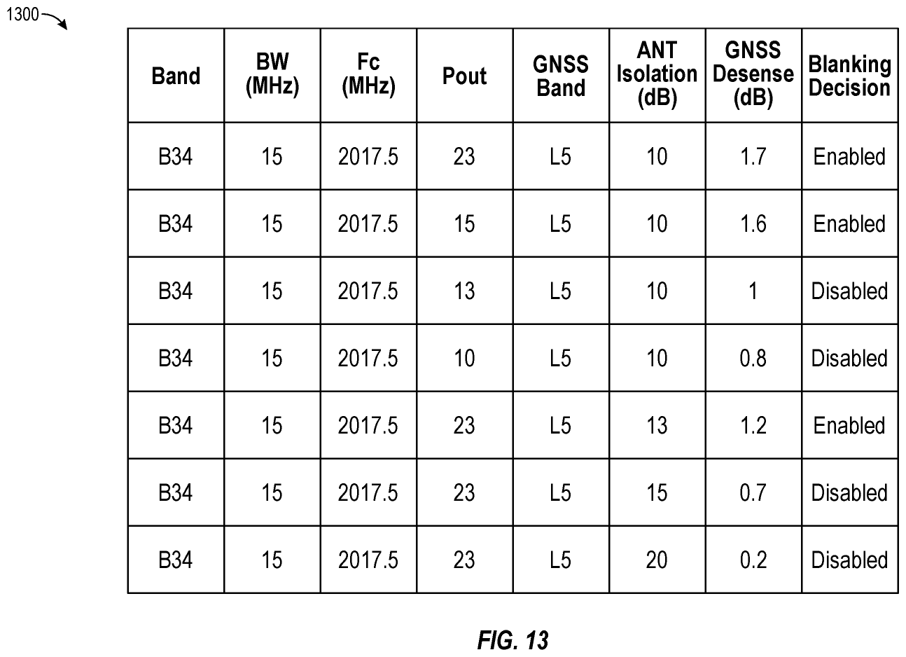

In some cases, a low pass filter (LPF) may be used for certain frequency bands, such as frequency band B34 (e.g., 2017.5 MHz). However, this LPF may not be capable of rejecting OOB noise at GNSS frequencies due to certain transmission powers of the UL transmission. FIG. 13 includes a table 1300 illustrating an example in which the UE may limit the blanking operation only to a particular transmission power and frequency band (e.g., B34) of the UL transmission at which GNSS desense exceeds the GNSS desense threshold. For example, as shown, the blanking operation may be enabled (e.g., the UE performs the blanking operation at 506 in FIG. 5) for frequency channel 2017.5 MHz having a transmission powers (e.g., Pout) of 23 dBm and 15 dBm and an antenna isolation of 10 dB since the resulting GNSS desenses (e.g., 1.7 dB and 1.6 dB, respectively) are greater than the 1 dB GNSS desense threshold. Similarly, the blanking operation may also be enabled for frequency channel 2017.5 MHz having a transmission power of 23 dBm and antenna isolation of 13 dB since the resulting GNSS desense (e.g., 1.2 dB) is greater than the 1 dB GNSS desense threshold. In contrast, the blanking operation may be disabled (e.g., the UE refrains from performing the blanking operation at 508 in FIG. 5) for the other transmission powers of the 2017.5 MHz frequency channel and antenna isolations illustrated in table 1300 since the GNSS desense threshold for these transmission powers/antenna isolations is not satisfied/exceeded.

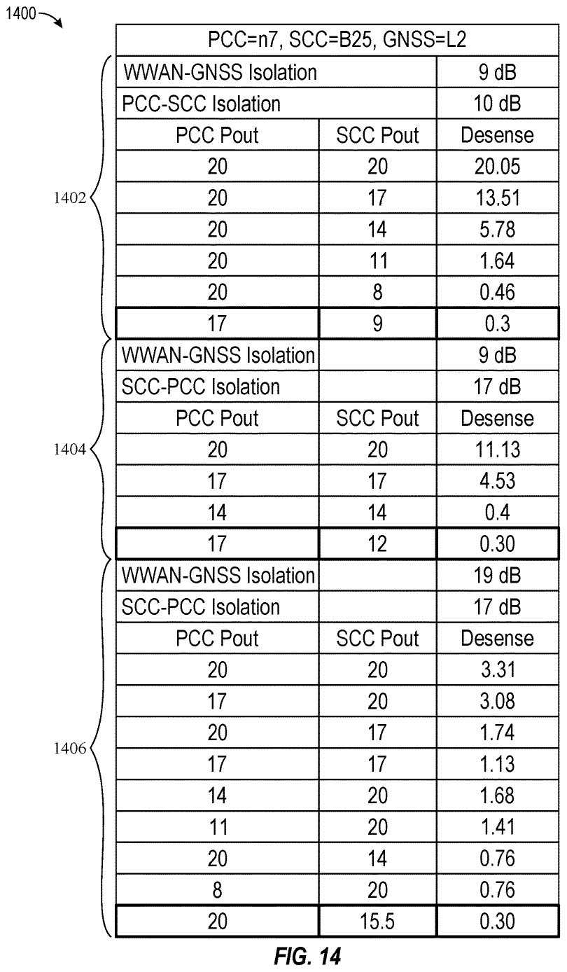

In some cases, for IMD-based scenarios, the GNSS desense threshold may be 0.3 dB. In static GNSS blanking, IDC blanking may be enabled for uplink carrier aggregation (ULCA) n7-B25-GNSS L2 for all PCC/SCC power ranges since in some power ranges the desense exceeds the threshold. In contrast, for IMD-based scenarios, using the techniques described above for dynamic GNSS blanking may allow the UE to limit the blanking operation only to a particular power range at which GNSS desense exceeds the GNSS desense threshold. FIG. 14 includes a table 1400 illustrating different combinations of PCC transmission power, SCC transmission power, and antenna isolations for which the blanking operation may be enabled or disabled.

For example, as shown at 1402, for an antenna isolation of 9 dB between a WWAN antenna (e.g., first antenna) and a GNSS antenna (e.g., second antenna) and an antenna isolation of 10 dB between the PCC antenna (e.g., first antenna) and SCC antenna (e.g., third antenna), the blanking operation may only be disabled (e.g., the UE refrains from performing the blanking operation at 508 in FIG. 5) for a PCC transmission power (e.g., PCC Pₒᵤₜ) of 17 dBm and an SCC transmission power (e.g., SCC Pₒᵤₜ) of 9 dBm, which result in a GNSS desense of 0.3 dB and which does not exceed the GNSS desense threshold of 0.3 dB.

Similarly, as shown at 1404, for an antenna isolation of 9 dB between the WWAN antenna (e.g., first antenna) and the GNSS antenna (e.g., second antenna) and an antenna isolation of 17 dB between the PCC antenna (e.g., first antenna) and SCC antenna (e.g., third antenna), the blanking operation may only be disabled for a PCC transmission power (e.g., PCC Pₒᵤₜ) of 17 dBm and an SCC transmission power (e.g., SCC Pₒᵤₜ) of 12 dBm, which result in a GNSS desense of 0.3 dB and which does not exceed the GNSS desense threshold of 0.3 dB.

Similarly, as shown at 1406, for an antenna isolation of 19 dB between the WWAN antenna (e.g., first antenna) and the GNSS antenna (e.g., second antenna) and an antenna isolation of 17 dB between the PCC antenna (e.g., first antenna) and SCC antenna (e.g., third antenna), the blanking operation may only be disabled for a PCC transmission power (e.g., PCC Pₒᵤₜ) of 20 dBm and an SCC transmission power (e.g., SCC Pₒᵤₜ) of 15.5 dBm, which result in a GNSS desense of 0.3 dB and which does not exceed the GNSS desense threshold of 0.3 dB.

In some cases, if an antenna isolation characterization tool is available, by having higher antenna isolation, the desense may drop accordingly, and PCC and SCC power thresholds may be adjusted at higher level automatically.

### Example Communications Devices

FIG. 15 depicts aspects of an example communications device 1500. In some aspects, communications device 1500 is a user equipment, such as UE 104 described above with respect to FIGS. 1 and 3A.

The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes one or more processors 1520. In various aspects, the one or more processors 1520 may be representative of one or more of receive processor 358, transmit processor 364, TX MIMO processor 366, and/or controller/processor 380, as described with respect to FIG. 3A. The one or more processors 1520 are coupled to a computer-readable medium/memory 1530 via a bus 1506. In certain aspects, the computer-readable medium/memory 1530 is configured to store instructions (e.g., computer-executable code) that when executed by the one or more processors 1520, cause the one or more processors 1520 to perform operations 500 described with respect to FIG. 5, operations 600 described with respect to FIG. 6, and/or operations 800 described with respect to FIG. 8, or any aspects related to these operations. Note that reference to a processor performing a function of communications device 1500 may include one or more processors performing that function of communications device 1500.

In the depicted example, computer-readable medium/memory 1530 stores code (e.g., executable instructions) for determining 1531, code for performing 1532, code for refraining 1533, code for obtaining 1534, code for calculating 1535, code for detecting 1536, and code for comparing 1537. Processing of the code 1531-1537 may cause the communications device 1500 to perform the operations 500 described with respect to FIG. 5, operations 600 described with respect to FIG. 6, and/or operations 800 described with respect to FIG. 8, or any aspects related to these operations.

The one or more processors 1520 include circuitry configured to implement (e.g., execute) the code stored in the computer-readable medium/memory 1530, including circuitry for determining 1521, circuitry for performing 1522, circuitry for refraining 1523, circuitry for obtaining 1524, circuitry for calculating 1525, circuitry for detecting 1526, and circuitry for comparing 1527. Processing with circuitry 1521-1527 may cause the communications device 1500 to perform the operations 500 described with respect to FIG. 5, operations 600 described with respect to FIG. 6, and/or operations 800 described with respect to FIG. 8, or any aspects related to these operations.

Various components of the communications device 1500 may provide means for performing the operations 500 described with respect to FIG. 5, operations 600 described with respect to FIG. 6, and/or operations 800 described with respect to FIG. 8, or any aspects related to these operations. For example, means for transmitting, sending or outputting for transmission may include the transceivers 354 and/or antenna(s) 352 of the UE 104 illustrated in FIG. 3A and/or transceiver 1508 and/or antenna 1510 of the communications device 1500 in FIG. 15. Means for receiving or obtaining may include the transceivers 354 and/or antenna(s) 352 of the UE 104 illustrated in FIG. 3A and/or transceiver 1508 and/or antenna 1510 of the communications device 1500 in FIG. 15. Means for determining, means for performing, means for refraining, means for obtaining, means for calculating, means for detecting, and/or means for comparing may be performed by one or more processors, such as the controller/processor 380, the transmit processor 364, and/or the receive processor 358 of the UE 104 illustrated in FIG. 3A and/or the processors 1520 of the communications device 1500 in FIG. 15.

### EXAMPLE CLAUSES

Implementation examples are described in the following numbered clauses:

Clause 1: A method for wireless communication by a user equipment (UE), comprising: determining an uplink (UL) transmission to be sent via a first radio access technology (RAT) radio of the UE will occur during an operating session of a second RAT radio of the UE; performing a blanking operation on signals received using the second RAT radio during the operating session when one or more thresholds associated with the UL transmission are satisfied; and refraining from performing the blanking operation on the signals received using the second RAT radio during the operating session when the one or more thresholds associated with the UL transmission are not satisfied.

Clause 2: The method of Clause 1, wherein the second RAT radio comprises a global navigation satellite system (GNSS) receiver.

Clause 3: The method of Clause 2, wherein the first RAT radio comprises a wireless wide area network (WWAN) radio.

Clause 4: The method of any of Clauses 1-3, wherein: the one or more thresholds comprise a power threshold associated with the UL transmission; performing the blanking operation comprises performing the blanking operation on the signals received using the second RAT radio when a transmission power of the UL transmission is greater than or equal to the power threshold; and refraining from performing the blanking operation comprises refraining from performing the blanking operation on the signals received using the second RAT radio when the transmission power of the UL transmission is less than the power threshold.

Clause 5: The method of Clause 4, wherein the power threshold associated with the UL transmission is based on an antenna isolation between a first antenna associated with the first RAT radio for the UL transmission and a second antenna associated with the second RAT radio for receiving the signals during the operating session.

Clause 6: The method of Clause 5, wherein the refraining further comprises refraining from performing the blanking operation on the signals received using the second RAT radio when the antenna isolation is greater than an antenna isolation threshold.

Clause 7: The method of any of Clauses 5-6, wherein the antenna isolation is a measured antenna isolation stored in a memory of the UE.

Clause 8: The method of Clause 7, further comprising: obtaining an initial power threshold and a power order from the memory of the UE; obtaining the measured antenna isolation from the memory of the UE; and calculating the power threshold associated with the UL transmission using the initial power threshold, the power order, and the measured antenna isolation.

Clause 9: The method of Clause 8, further comprising: determining a change in an automatic gain control (AGC) power associated with the UL transmission between time periods; and comparing the AGC power associated with the UL transmission to the power threshold, wherein: the blanking operation is performed on the signals received using the second RAT radio during the operating session when the AGC power associated with the UL power is greater than or equal to the power threshold; and the blanking operation is refrained from being performed on the signals received using the second RAT radio during the operating session when the AGC power associated with the UL power is less than the power threshold.

Clause 10: The method of Clause 9, wherein the change in the AGC power associated with the UL transmission occurs between time slots or symbols.

Clause 11: The method of any of Clauses 1-10, wherein: the one or more thresholds comprise an overall intermodulation distortion (IMD) threshold associated with the UL transmission; performing the blanking operation comprises performing the blanking operation on the signals received using the second RAT radio when an IMD of the UL transmission is greater than or equal to the overall IMD threshold; and refraining from performing the blanking operation comprises refraining from performing the blanking operation on the signals received using the second RAT radio when the IMD of the UL transmission is less than the overall IMD threshold.

Clause 12: The method of Clause 11, wherein the overall IMD threshold associated with the UL transmission is based on at least one of an antenna isolation between: a first antenna associated with the first RAT radio for the UL transmission and a second antenna associated with the second RAT radio for receiving the signals during the operating session; or a third antenna associated with the first RAT radio for the UL transmission and the second antenna associated with the second RAT radio.

Clause 13: The method of Clause 12, wherein the refraining further comprises refraining from performing the blanking operation on the signals received using the second RAT radio when the antenna isolation is greater than an antenna isolation threshold.

Clause 14: The method of any of Clauses 12-13, wherein the antenna isolation is a measured antenna isolation stored in a memory of the UE.

Clause 15: The method of any of Clauses 12-14, wherein: the first antenna is a primary component carrier (PCC) antenna of the UE for transmitting a PCC; and the third antenna is a secondary component carrier (SCC) antenna of the UE for transmitting an SCC.

Clause 16: The method of Clause 15, further comprising: determining a first IMD value for the PCC antenna of the UE based on an IMD of the PCC at a maximum transmit power of the PCC, a power order associated with the PCC, the maximum transmit power of the PCC, a power order associated with the SCC of the UE, a maximum transmit power of the SCC, and an antenna isolation between the PCC antenna and an SCC antenna; and determining a second IMD value for the SCC antenna of the UE based on the IMD of the PCC at the maximum transmit power of the PCC, the power order associated with the PCC, the maximum transmit power of the PCC, the power order associated with the SCC, the maximum transmit power of the SCC, and the antenna isolation between the PCC antenna and the SCC antenna.

Clause 17: The method of Clause 16, further comprising: determining a first IMD threshold based on the first IMD value, the antenna isolation between the PCC antenna and the SCC antenna, and the antenna isolation between the PCC antenna and the second antenna associated with the second RAT radio; and determining a second IMD threshold based on the second IMD value, the antenna isolation between the PCC antenna and the SCC antenna, and the antenna isolation between the SCC antenna and the second antenna associated with the second RAT radio.

Clause 18: The method of Clause 17, further comprising determining the overall IMD threshold based on the first IMD threshold, the second IMD threshold, and a noise threshold.

Clause 19: The method of Clause 18, further comprising: detecting a change in an automatic gain control (AGC) power associated with the UL transmission between time periods; and determining, in response to the detected change in the AGC power, an IMD value for the UL transmission based on the power order associated with the PCC, a transmission power associated with the PCC, the power order associated with the SCC, and a transmission power associated with the SCC.

Clause 20: The method of Clause 19, further comprising comparing the IMD value for the UL transmission to the overall IMD threshold, wherein: the blanking operation is performed on the signals received using the second RAT radio during the operating session when the IMD value is greater than or equal to the overall IMD threshold; and the blanking operation is refrained from being performed on the signals received using the second RAT radio during the operating session when the IMD value is less than the overall IMD threshold.

Clause 21: The method of any of Clauses 1-20, wherein the one or more thresholds are based on at least one of a transmission bandwidth of the UL transmission, a transmission channel of the UL transmission, a transmit power of the UL transmission, or an antenna isolation between a first antenna associated with the first RAT radio for the UL transmission and a second antenna the second RAT radio for receiving the signals during the operating session.

Clause 22: The method of any of Clauses 1-21, wherein the refraining further comprises refraining from performing the blanking operation on the signals received using the second RAT radio when an antenna isolation is greater than an antenna isolation threshold, the antenna isolation being between a first antenna associated with the first RAT radio for the UL transmission and a second antenna associated with the second RAT radio for receiving the signals during the operating session.

Clause 23: A method for wireless communication by a user equipment (UE), comprising: determining an uplink (UL) transmission to be sent via a first radio access technology (RAT) radio of the UE will occur during an operating session of a second RAT radio of the UE; and refraining from performing a blanking operation on signals received using the second RAT radio during the operating session when an antenna isolation, between a first antenna associated with the first RAT radio for the UL transmission and a second antenna associated with the second RAT radio for receiving the signals during the operating session, is greater than a threshold antenna isolation.

Clause 24: The method of Clause 23, further comprising performing the blanking operation on the signals received using the second RAT radio during the operating session when the antenna isolation is less than the threshold antenna isolation and when one or more thresholds associated with the UL transmission are satisfied.

Clause 25: An apparatus, comprising: one or more processors configured to execute the instructions stored on one or more memories and to cause the apparatus to perform a method in accordance with any of Clauses 1-24.

Clause 26: An apparatus, comprising means for performing a method in accordance with any of Clauses 1-24.

Clause 27: A non-transitory computer-readable medium comprising executable instructions that, when executed by one or more processors of an apparatus, cause the apparatus to perform a method in accordance with any of Clauses 1-27.

Clause 28: A computer program product embodied on a computer-readable storage medium comprising code for performing a method in accordance with any of Clauses 1-24.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) for wireless communication, comprising:
one or more processors configured to execute instructions stored on one or more memories and to cause the UE to:
determine an uplink (UL) transmission to be sent via a first radio access technology (RAT) radio of the UE will occur during an operating session of a second RAT radio of the UE;
perform a blanking operation on signals received using the second RAT radio during the operating session when one or more thresholds associated with the UL transmission are satisfied; and
refrain from performing the blanking operation on the signals received using the second RAT radio during the operating session when the one or more thresholds associated with the UL transmission are not satisfied.

2. The UE of claim 1, wherein the second RAT radio comprises a global navigation satellite system (GNSS) receiver.

3. The UE of claim 2, wherein the first RAT radio comprises a wireless wide area network (WWAN) radio.

4. The UE of claim 1, wherein:
the one or more thresholds comprise a power threshold associated with the UL transmission;
to perform the blanking operation, the one or more processors are configured to cause the UE to perform the blanking operation on the signals received using the second RAT radio when a transmission power of the UL transmission is greater than or equal to the power threshold; and
to refrain from performing the blanking operation, the one or more processors are configured to cause the UE to refrain from performing the blanking operation on the signals received using the second RAT radio when the transmission power of the UL transmission is less than the power threshold.

5. The UE of claim 4, wherein the power threshold associated with the UL transmission is based on an antenna isolation between a first antenna associated with the first RAT radio for the UL transmission and a second antenna associated with the second RAT radio for receiving the signals during the operating session.

6. The UE of claim 5, wherein to refrain from performing the blanking operation, the one or more processors are configured to cause the UE to refrain from performing the blanking operation on the signals received using the second RAT radio when the antenna isolation is greater than an antenna isolation threshold.

7. The UE of claim 5, wherein the antenna isolation is a measured antenna isolation stored in the one or more memories of the UE.

8. The UE of claim 7, wherein the one or more processors are further configured to cause the UE to:
obtain an initial power threshold and a power order from the one or more memories of the UE;
obtain the measured antenna isolation from the one or more memories of the UE; and
calculate the power threshold associated with the UL transmission using the initial power threshold, the power order, and the measured antenna isolation.

9. The UE of claim 8, wherein the one or more processors are further configured to cause the UE to:
determine a change in an automatic gain control (AGC) power associated with the UL transmission between time periods; and
compare the AGC power associated with the UL transmission to the power threshold, wherein:
to perform the blanking operation, the one or more processors are configured to cause the UE to perform the blanking operation on the signals received using the second RAT radio during the operating session when the AGC power associated with the UL power is greater than or equal to the power threshold; and
to refrain from performing the blanking operation, the one or more processors are configured to cause the UE to refrain from performing the blanking operation on the signals received using the second RAT radio during the operating session when the AGC power associated with the UL power is less than the power threshold.

10. The UE of claim 9, wherein the change in the AGC power associated with the UL transmission occurs between time slots or symbols.

11. The UE of claim 1, wherein:
the one or more thresholds comprise an overall intermodulation distortion (IMD) threshold associated with the UL transmission;
to perform the blanking operation, the one or more processors are configured to cause the UE to perform the blanking operation on the signals received using the second RAT radio when an IMD of the UL transmission is greater than or equal to the overall IMD threshold; and
to refrain from performing the blanking operation, the one or more processors are configured to cause the UE to refrain from performing the blanking operation on the signals received using the second RAT radio when the IMD of the UL transmission is less than the overall IMD threshold.

12. The UE of claim 11, wherein the overall IMD threshold associated with the UL transmission is based on at least one of an antenna isolation between:
a first antenna associated with the first RAT radio for the UL transmission and a second antenna associated with the second RAT radio for receiving the signals during the operating session; or
a third antenna associated with the first RAT radio for the UL transmission and the second antenna associated with the second RAT radio.

13. (canceled)

14. (canceled)

15. The UE of claim 12, wherein:
the first antenna is a primary component carrier (PCC) antenna of the UE for transmitting a PCC; and
the third antenna is a secondary component carrier (SCC) antenna of the UE for transmitting an SCC.

16. (canceled)

17. (canceled)

18. (canceled)

19. (canceled)

20. (canceled)

21. The UE of claim 1, wherein the one or more thresholds are based on at least one of:
a transmission bandwidth of the UL transmission,
a transmission channel of the UL transmission,
a transmit power of the UL transmission, or
an antenna isolation between a first antenna associated with the first RAT radio for the UL transmission and a second antenna the second RAT radio for receiving the signals during the operating session.

22. The UE of claim 1, wherein to refrain from performing the blanking operation, the one or more processors are further configured to cause the UE to refrain from performing the blanking operation on the signals received using the second RAT radio when an antenna isolation is greater than an antenna isolation threshold, the antenna isolation being between a first antenna associated with the first RAT radio for the UL transmission and a second antenna associated with the second RAT radio for receiving the signals during the operating session.

23. A method for wireless communication by a user equipment (UE), comprising:
determining an uplink (UL) transmission to be sent via a first radio access technology (RAT) radio of the UE will occur during an operating session of a second RAT radio of the UE;
performing a blanking operation on signals received using the second RAT radio during the operating session when one or more thresholds associated with the UL transmission are satisfied; and
refraining from performing the blanking operation on the signals received using the second RAT radio during the operating session when the one or more thresholds associated with the UL transmission are not satisfied.

24. (canceled)

25. (canceled)

26. (canceled)

27. A method for wireless communication by a user equipment (UE), comprising:
determining an uplink (UL) transmission to be sent via a first radio access technology (RAT) radio of the UE will occur during an operating session of a second RAT radio of the UE; and
refraining from performing a blanking operation on signals received using the second RAT radio during the operating session when an antenna isolation, between a first antenna associated with the first RAT radio for the UL transmission and a second antenna associated with the second RAT radio for receiving the signals during the operating session, is greater than a threshold antenna isolation.

28. The method of claim 27, further comprising performing the blanking operation on the signals received using the second RAT radio during the operating session when the antenna isolation is less than the threshold antenna isolation and when one or more thresholds associated with the UL transmission are satisfied.

29. A user equipment (UE) for wireless communication, comprising:
one or more processors configured to execute instructions stored on one or more memories and to cause the UE to:
determine an uplink (UL) transmission to be sent via a first radio access technology (RAT) radio of the UE will occur during an operating session of a second RAT radio of the UE; and
refrain from performing a blanking operation on signals received using the second RAT radio during the operating session when an antenna isolation, between a first antenna associated with the first RAT radio for the UL transmission and a second antenna associated with the second RAT radio for receiving the signals during the operating session, is greater than a threshold antenna isolation.

30. The UE of claim 29, wherein the one or more processors are further configured to cause the UE to perform the blanking operation on the signals received using the second RAT radio during the operating session when the antenna isolation is less than the threshold antenna isolation and when one or more thresholds associated with the UL transmission are satisfied.
